(19) United States
(12) Patent Application Publication
(10) Pub. No.: US 2005/0261864 A1
(43) Pub. Date: Nov. 24, 2005

(54) Automated quality assurance method and apparatus and method of conducting business

(76) Inventors: James A. Edwards, Jefferson, GA (US); James S. Tomlin, Gainsville, GA (US)

Correspondence Address: John P. Iuther;Newman & Newman LLP, Suite 610, 505 Fifth Avenue South, Seattle, WA, 98104, US

(21) Appl. No.: 11/114,308

(22) Filed: Apr. 25, 2005

Related U.S. Application Data
(63) Continuation-in-part of application No. 10/667,154, filed on Sep. 19, 2003, now Pat. No. 6,922,652.

(51) Int. Cl. G06F 15/00

(52) U.S. Cl. 702/127

(57) ABSTRACT

The present invention provides a dynamic continuous and/or semi-continuous and/or static product measurement characterizing and identifying system, apparatus and computer program for food stuffs and food product portions and other objects comprising a conveyor means for transport of product or object to be measured to more than one or a plurality of detection regions to detect information selected from height, length, width, dimensional, spatial or topological characteristics, coloring characteristics, moisture content, weight, temperature, odor characteristics, taste characteristics and the presence of pathogens while conveyed products are in motion or static or a combination thereof on said conveying means.

### RELATED APPLICATIONS

This application is a continuation-in-part of U.S. patent application Ser. No. 10/667,154 filed Sep. 19, 2003.

### COPYRIGHT NOTICE

Copyright 2005 Processing Solutions Equipment, Inc. All rights reserved. A portion of the disclosure of this patent application/patent document contains material which is subject to copyright protection. The copyright owner has no objection to the facsimile reproduction by anyone of the patent document or the patent disclosure as it appears in the United States Patent and Trademark office file and records.

### FIELD OF THE INVENTION

The present invention relates to a method, computer program, system, apparatus, and method of doing business thereby, for automating quality control functions in processed food production and preparation, inclusive of such items as beef, poultry and other food segments and portions, and more particularly to automated means, method and system for carrying out such quality control functions as dimensional sizing, weighing and temperature testing and spatial characteristic determination of food and other products.

### BACKGROUND OF THE INVENTION

To further efficiency in modern food product processing and packaging operations, and in food portion control, efforts have been made to replace formerly manually conducted operations with automated procedures and methods. Such methods and products are particularly desirable in quality assurance operations and procedures to ensure that regulated and mandated quality standards are consistently adhered to throughout production operations.

For example, in U.S. patent application publication No.: U.S. 2003/0024744 (Feb. 6, 2003) to Ring, there is disclosed a data acquisition and/or control method and device which employs a conveyor weigh scale, or “weigh scale control”, which is said to automatically determine a crucial sample period for accurately weighing various food products. The described method also employs an algorithm for data acquisition and control in a food product weighing operation. In this method, a conveyor weigh scale senses a dynamic weight of a product as it passes over a weigh scale, which can be expressed as a weight waveform of sensed weight over time as the product passes over the scale. As described, an accurate weight reading for the moving product is made during a brief sample period within the waveform where weight readings are most constant and representative of the static weight of the product. This method is said to be an advantage over conventional continuously moving product scales which use laser sensor or photosensitive components, such as an optical or other external triggering device. These devices are used to detect the entry of a product into a weigh scale, and then actuate the scale which uses fixed timing numbers to estimate the position of the sample period on a weight waveform to make weight measurements.

The improvement associated with this method is said to be the provision of a software algorithm for a weight scale associated with a continuously moving conveyor which is capable of positioning the sample period on each product weight waveform and in which the weight and speed of the product passing over the scale does not affect the positioning of the sample period. The algorithm calculates the sample period using waveform slope characteristics.

The weight measurement method described above is also said to be useful with such conventional food processing methods, such as illustrated, for example, in U.S. Pat. Nos. 5,704,265; 5 and 5,724,874 which is a slicing machine with a conveyor drive/classifier system that is responsive to a weigh scale to direct products within a weight tolerance to an “accept conveyor, and out-of-weight tolerance products to a “reject” conveyor. The slicing machine produces a series of stacks of food loaf slices which move outwardly of the machine on an input conveyor which, as described, continuously senses the weight of the sliced product appearing on the scale, which, in turn, outputs a continuous succession of weight readings of samples at regular time intervals to define corresponding waveforms, and which are characterized as dynamic weight measures of product. The assemblage enables rapid weight measurement on the order of five-hundred samples per second, with a rapid conveyor product speed of over one-hundred product stacks per minute. The system is applicable to all different types of commercial food product loaves, such as ham, beef, pork, fish in a variety of shapes and sizes, and in differently shaped stacks of food product.

Other conventional food processing measurement systems include two-dimensional (2-D) imaging systems to determine length and width, and used, for example, in oyster measurements and in sizing other food objects. These systems typically produce a 2-D image which corresponds to an amount of light and corresponding current, which is picked up by pixels of a charge-coupled device (CCD) camera, and which is positioned to receive images from a particular area. These systems are also able to obtain individual weight data per product, such as the weight of an oyster, by correlating a sample group weight of food products with pixel data using an equation relating to 2-D image and volume.

Further refinements to such methods of determining food product volume employ three-dimensional (3-D) optical volume measurement such as disclosed in U.S. Pat. No. 6,369,401 to Lee. In this method, one or more lines of radiation are projected from a radiation source, such as a laser light source, onto a food object, and thereafter detecting lines of radiation reflected from the object. Reflected radiation is compared with that reflected from a reference surface to determine the height, length and width of an object at a location corresponding to at least one line of radiation impinging on the object. As further disclosed in this method, several laser lines are impinged onto a surface area on which a food product object is located, and onto a reference surface of which no food product object is located. A light sensitive device, such as a camera, having a plurality of pixel elements that can receive light from a plurality of surface locations, which is light reflected from the food product object, or surface, is used to determine light intensity received, and displacement of laser lines relative to a reference location.

Raw image data from the camera is received by a central processing unit (CPU), which determines the binary image of projected area to determine length and width dimensions. The CPU also uses laser line displacement data to determine object height at the various locations of the object, all of which data is then used by the CPU to calculate the product or object volume.

Another food product data processing/process control system and method is discloses in International Patent Application No. PCT/GB99/00766 to whitehouse. In this system, a food product traverses an inspection region on a conveyor belt, and a transducer determines shape, size and cross-section of the product in the inspection region. Data generating transducers can be rotated about an object or product to be measured so as to inspect the whole of the product surface for accurate size and shape measurements, with signals generated when a length of product enters and leaves an inspection region, and with computation means capability to produce product arrival and product departure signals.

As also disclosed, data generating laser displacement transducers may be mounted in a ring pattern around or at an inspection site or region, and situated to direct their beams through a gap between two in-line conveyors, with the ring being driven by a servo motor, and with output data of the transducers logged by a computer means.

In yet another example of conventional product characteristic data gathering in commercial food processing techniques, U.S. patent application publication No. U.S. 2002/0014444 (Feb. 7, 2002) to Hebrank describes a method and apparatus for automated poultry egg classification. A conveying system is used transport eggs to an inspection station where, among other characteristics, egg temperature is measured by a thermal codling system which measures temperature by detecting corresponding infrared radiation, thereby generating corresponding signals which are sent to a controller, or CPU.

Currently, in conventional poultry, meat and processed food plant operations in general, quality control and assurance techniques are oftentimes labor intensive. For example, in a typical poultry plant operation, a sample of all boneless breast meat products is tested for size, weight, temperature and other characteristics and/or defects or standard deviations by method(s) which require at least some aspect of manual labor or exertion to produce measurable data, e.g. a quality assurance data point. Usually, to obtain weight measurements, an employee is required to extract a sample of product from a product process line and place it on a scale for weighing. The product weight can then be recorded in a log, or other database, such as a computer database program.

Product thickness, or other dimensions of width and length, are also typically manually measured, such as, for example, by using calipers, which data is also manually logged, or otherwise fed to a database. The temperature of each product sample is also manually checked and recorded. Such labor intensive efforts are undesirable in that up to two minutes or more is required to check each product sample, which results in significantly less data generated than if performed by automatic machine means. Additionally, such human intervention with quality assurance checking procedures invariably results in inconsistent or even fabricated data generation leading to unnecessarily unreliable quality assurance measures.

It is therefore desirable and an object of the present invention to provide a completely automated method and system to generate all data contemplated as required for any processed food product processing quality assurance program or other product standardization or portion control operation.

It is a further object of the present invention to provide such an automated method in which a plurality of food processing or subject matter measurements may be made as desired on a conveyed means in conjunction with computer program code and/or data processing means.

### SUMMARY OF THE INVENTION

In accordance with those objects and desires set forth above, the present invention provides a method and apparatus, computer program code and method of doing business thereby, of automating quality control and assurance in commercial food processing, packaging and handling. In this inventive product measuring system total product or object measurement, e.g. length, width, height, weight, spatial characteristics, volume and temperature measurement functions and other product/object characteristic determinations, such as odor and pathogen content, are combined in an automated means, in which one or more sample food products on an automated conveying means is transported to one or a plurality of inspection sites or regions, which can be located in a housing means. In accordance with this invention, once transported to the desired location(s), a product sample may traverse one or more inspection regions, wherein it is preferred that out of a plurality of possible inspection means at least one detection means is provided which is effective to measure product dimensions and spatial characteristics, e.g., the height, length and width, volume and generally the 3-D topography and the unique spatial characteristics of a sample product; another detection means measure is provided to measure the weight of said sample product; and an additional detection means is present to measure the temperature of the sample product. Multiple detection means are contemplated for use in a variety of embodiments of this invention to measure and/or detect any desired characteristic of a food product or any object traversing an inspection region. The system can also be optionally provided with accept output conveyor means and reject output conveyor means, for example, for defective products, or products falling outside of standardization parameters, as desired.

The inventive system is also contemplated for use with one or more executable programs to generate, process and store data in a database and to operate all contemplated functions of the invention, and to also include bar code generating means to codify product measurement characteristics and any other conventional data processing technology.

The present invention as to its manner of operation and further objects and advantages is best understood by reference to the following Detailed Description of Preferred Embodiments, accompanied by reference to the drawing.

### BRIEF DESCRIPTION OF THE DRAWINGS

FIG. 1 is a perspective schematic view of an embodiment of the inventive measuring method and system for automated dynamic product configuration/dimensional determination, weight and temperature determination.

FIG. 2 illustrates a flow diagram of a temperature sensor and conveyor and functions as implemented by computer program code in accordance with the invention.

FIG. 3 illustrates a flow diagram of an optical sensor and function as implemented by computer program code in accordance with the invention.

FIG. 4 illustrates a flow diagram of a weight sensor and function as implemented by a computer program code in accordance with the invention.

FIG. 5 illustrates a flow diagram of object processing as implemented by computer program code in accordance with the invention.

### DETAILED DESCRIPTION OF THE PREFERRED EMBODIMENTS

All patent references, published patent applications and literature references referred to or cited herein are expressly incorporated by reference to the same extent as if each were specifically and individually indicated to be incorporated by reference. Any inconsistency between these publications and the present disclosure is intended to and shall be resolved in favor of the present disclosure.

The present invention provides an automated food product and object measuring system which is particularly suited for use in food plant product quality assurance and control operations. In this invention, a conveyor means, such as a servo-computer operated conveyor belt, transports one or more, or a plurality of products, to one or more inspection or measurement regions to be measured for, e.g. quality control purposes, product standardization and packaging, or for any reason contemplated. The product may be a poultry part or food portion, such as a boneless chicken breast, or a beef or pork section or portion, a whole fish, or any food or prepared food product contemplated, such as chicken or beef pies, prepared casseroles and the like, or any non-food product desired for characteristics measurement and/or identification.

In this exemplified embodiment, once entering an inspection region by way of conveyor means, the product is subjected to a first detection means for dimensional or spatial dimensional or otherwise total topological and/or 2-D or 3-D detection and determination including, for example, the product's height, length and width, and spatial and/or topological characteristics and one or more additional detection means, for example, for product weight determination, and detection means for product temperature determination, all of which collected information can be automatically processed and stored in a database. The order of placement of detection means can be that of any order as desired and is not critical to the practice of this invention. However, in a preferred embodiment, there is thought to be an advantage to conducting a spatial or topological determination prior to a temperature determination, as the temperature of an object can then be measured at an optimum local of an object, for example, the thickest portion of an object as desired. The inventive measuring system provides for an efficient, human-intervention-free and accurate snap-shot product review at any point desired in a food product production line, with a concomitant reduction in labor required for its undertaking, and an elimination of a specially trained labor force required for product quality control and assurance operations. The inventive system by way of its conveyed continuous operation also enables a significant increase over conventional manual operations in product sample(s) review and quality control data collection.

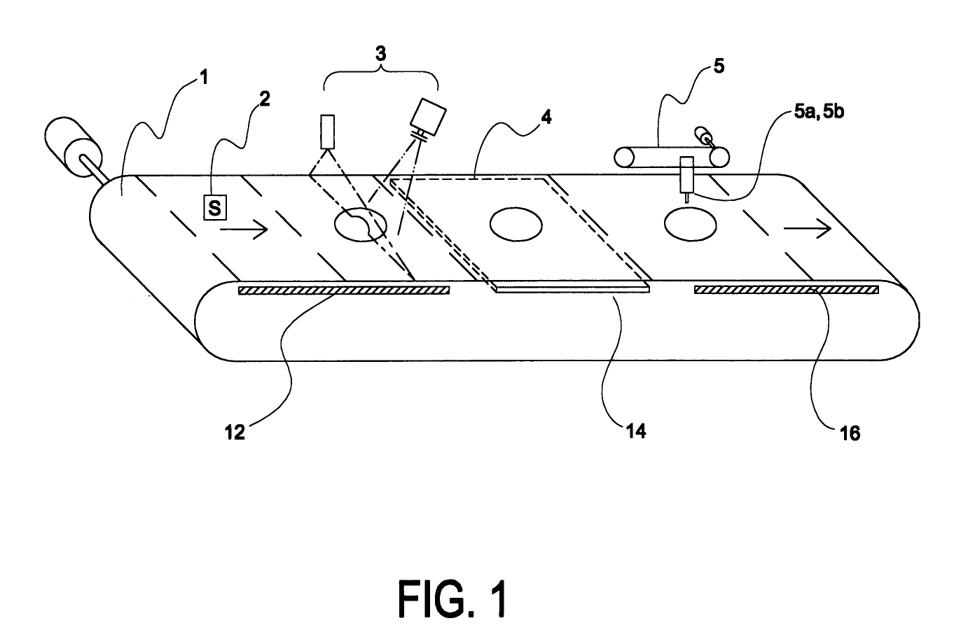

Turning now to FIG. 1, there is shown a perspective schematic view of a preferred embodiment of the inventive product sample measuring/quantizing system for automated dynamic product configuration/dimensional determination, weight and temperature determination. In FIG. 1, a conveyor means 1, such as a standard conveyor belt, transports one or more, or a plurality, of food product samples 2, such as a poultry portion or beef or pork food portion for human, and/or animal consumption, to one or more inspection regions. An operator can manually place a food product 2 on the conveyor means 1, or it may be deposited from a hopper means (not shown) or by any suitable conventional deposit means desired or contemplated. The speed of conveyor means 1 can be set and controlled by a computer means (not shown) or other Central Processing Unit (CPU), with stop/start and food product entry and depart functions automated and controlled as well by the computer means or CPU, or other control function means.

Upon being conveyed to a first inspection region 12, a first detection means 3 is similarly situated and is effective to detect and make 3-D measurements and/or determine product configuration of the sample product. First detection means 3 can be any known or conventional device, preferably such as a scanning device, for example, a laser scan, to determine the height, length and width of the sample product at any cross-sectional plane of the product to provide an accurate spatial, topological, two- or three-dimensional product configuration output profile and volume of the product. Irregularly shaped food products such as boneless chicken parts have a varying topography and are preferably checked and measured for total length, mean and average height and width through several cross sectional portions or preforms of the sample. If preferred, two-dimensional measurements are also contemplated.

Scanners contemplated as useful in this example as a first detection means, and in this invention in general, can be any conventionally available technology, such as, for example, two and three-dimensional optical sizing systems employing camera means positioned in inspection region 12 to receive images from the inspection region. Such devices are well known, of which examples are discussed in U.S. Pat. No. 6,369,401, the disclosure of which is incorporated herein by reference. Another example of conventional 2-D or 3-D spatial imaging methodology or technology useful in this invention includes that disclosed in the Opton non-contact whole field 3-D Moire measurement machine series, such as first described in Takeda, “Fourier Transform profilometry for the automatic measurement of 3-D object shapes”, University of Electrocommunications (1982), all of which is incorporated by reference herein. In this system an optical sensor head which acquires images is provided, and which are based on 3-D calculations. In operation, a grating pattern is projected onto an object to be topologically characterized from a grating projector by way of a strobe means, e.g., a Xenon strobe, with deformed grating patterns of the surface of the object to be measured by being picked up and entered into a computer by way of detection from a change-coupled device (CCD) camera which digitizes the grating images and general B/W images on the object. As is known a CCD camera contains light sensitive integrated circuits which store and display the data for an image in such a way that each picture element (pixel) in the image is converted into an electrical charge of which its intensity is related to a color of the color spectrum. For example, in a system supporting 65,535 colors, there will be a separate value for each color that can be stored and recovered. This method and system is known for its improved shutter speed and effectiveness in imaging and use with moving objects to produce accurate shape and color measurements with wide field, high resolution and high speed measurements via the use of high speed, strobe aided cameras. The system is also equipped with a laser pointer for auto-focusing and controlling the orientation of the camera, a lighting means, e.g. a white light lamp to illuminate an object targeted for measurement and for illuminating ink lines and reference marks as desired. An optical probe means for uniaxial point measurement, or a snap-shot one point 3-D measurement, at any point desired in an object is another feature. As also discussed, a grating shifting mechanism can be employed to improve data spatial resolution.

As mentioned, in operation a grating pattern is projected onto a surface to be measured which is deformed according to an object's particular topography. The deformed grating pattern taken into a computer by the CCD camera is saved as a digital image. With a flat surface to be measured located at a reference position, for example, the most desirable focus position, the deformed image received by the camera will be one of substantially straight lines which may have a particular pitch characteristic. For a non-flat surface at a reference position to be measured, the deformed image received by the camera will be one of non-straight lines and a changed grating pitch, with a change of light intensity of the grating image, which is measured and processed. Thus, for example, the first image of a flat or substantially flat object, such as a conveyor belt surface, is used a reference wave with a certain frequency in comparison with a second image of a deformed wave with its phase modulated. The phase difference can then be calculated, for example, by use of an algorithm, such as the Moire 3-D algorithm as based on the Takeda publication, between the reference and deformed waves for individual pixels of the CCD camera, with a depth (Z coordinate) and X and Y coordinates obtained. Many other 2-D or 3-D imaging/topological measuring methods and systems are known, any of which are contemplated for use herein.

By way of a series of snap shots of cross-sectional segments of a sample product, providing height, length and width data of a varying topography of a products' configuration, the product's volume may be determined, as well as its spatial characteristics, such a detailed topographic map, from which a host of desired information can be extracted, including, for example, maximum thickness and length along any axis of interest. Other information operations which might be performed include, for example, product outline template checking, shape irregularity measurement such as for unusual protuberances, shape checking, and thinness and thickness checking over selected areas, all of which can be automatically calculated and determined by computer means or a CPU station. As can be seen, an enormous amount of reliable data, and sample product information, can be gathered and logged or processed in a rapid amount of time to control product output quality as precisely as desired or required.

Further proceeding into another inspection region, inspection region 14 in FIG. 1, by means of conveyor means 1, product sample 2 is next subjected to a weight detection or determination means 4 which is effective to determine total product sample weight. Weight detection means 4 situated in inspection region 14 can be of any known conventional technology, such as a load cell or other device effective for dynamic weight measurement of products on a continuously moving weigh conveyor. Examples of such conventional continuous weighing technology suitable for use in the present invention are provided, for example, in U.S. patent application Publication No. U.S. 2003/0024744. Any of the many conventional load cell weighing systems or indicators are suitable for use in this invention, including, for example, that provided by Weigh-Tronix, for weighing mixed items of varying size and weight, i.e. irregularly shaped and configured food product samples, in high speed conveyed weight validation. Other preferred suitable examples useful herein include such load cell-based process weighing systems as provided by BLH Vishay weight indicators and products, and that of Sensortronics and RL Scales, Inc., which provide load cell weighing systems for use in automatic check out counters, as well as in picking/shipping systems and general industrial applications, any of which such conventional weighing technology is contemplated for use in this invention.

Having undergone dimensional/spatial/topological configuration, volume and weight analysis, product samples next are transported in FIG. 1 by conveyor means 1 into a third inspection region 16 for temperature determination/analysis or temperature verification. As shown in FIG. 1, a temperature detection means 5 is situated in or contemporaneous to inspection region 16, and is effective for continuous dynamic temperature measurement of food product samples continuously traversing region 16. In this preferred embodiment, a temperature prove means 5a, 5b is indicated for use, which may be a computer engaged probe insertable in any cross sectional portion of a sample product, such as one of irregular topographical product configuration, to provide an average or mean temperature per piece or product sample, and to ensure accurate temperature measurement. As is known, dwell times of such temperature measurement products can be set as desired to further ensure accurate product temperature measurement on a continuously moving conveyed sample production line.

Also suitable for use in this invention are non-contact temperature measurement devices, such as radiation thermo-detection means which are capable of providing accurate and reliable temperature determinations and values at a distance over a continuously moving conveyed line. Such instruments, as known, employ optical components which can focus infrared radiation onto a solid-state detection where it is converted into an electrical signal and read out as temperature on a digital display. Some commercial examples include, for example, equipment produced by Raytek as the Thermalert series of products.

The conveying means of the invention can be any movable belt or moving surface means composed of, for example, antibacterial materials to avoid food product contamination, and can be actuated and speed controlled by a servo or computer means. The conveyor means in accordance with the invention may be continuously conveyed in product measurement operation, or, for example, stopped, started, or moved or pulsed at intermittent speeds, depending on the measuring or detection operation desired or contemplated, the desired speed of data generation, or any other production or business reason contemplated. The conveyor means is also preferably constructed of materials conducive and complimentary to detection measurement, such as light pulsed measurement and the like of product sample characteristics and with surface reference characteristics stored in a database in a computer means. It is also contemplated that the system be equipped with one or more conveying means for accepted sample products and for rejected sample products, with rejected samples being diverted to a conveyor or area by an acuateable component or means, such as a pop-up roller or automatically insertable panel or gate means, or other directing member means. The conveyor means can extend through one or more detection regions in a perpendicular or angled fashion, and be of a substantially flat surface or concave or convex in portions depending upon such factors as, for example, detection means employed, physical characteristics of a sample being measured, and the shape of a sample product to be measured.

Any conventional detection means is contemplated for use in the present invention, and which can be placed in any order in conjunction with the conveyer means. For example, in some food dye colored products, a color detection means may be desired, or in other applications useful to grade fish species via their natural color characteristics such as salmon, or beef sources or to detect blood spots in poultry and fish. Beef marbling may be detected in such a continuous operation to grade certain cuts, or to determine fat percentage in ground beef. Moisture content detection means may be employed, for example, along with weight and temperature measurements to gauge product shrinkage in processing and packaging operations. The employ of smell and order detection, flavor enhancement and microbial detection means are also contemplated for use in this invention.

Smell and/or odor detection in accordance with the present invention may be conducted by any conventional (and non-conventional, or proprietary means) such as recognition of odor detections methods discussed in Roppel et.al., “Biologically Inspired Pattern for Odor Detection” and Roppel et.al., “Design of a low-power, portable sensor system using embedded neural networks and hardware processing”, IUCNN 1999, Washington D.C. Odor control techniques are also contemplated which may be, for example, in the form of atomizing spray nozzles for automatically releasing chemicals to destroy odors and/or bacteria that may grow and cause odor build-up in food and/or meatpacking or other product processing plants, optionally in conjunction with means employed for detecting unacceptable odor levels. Other means which may be employed herein include biosensors for sensory analysis such as “electronic noses” and “electronic tongues”. Electronic noses usually comprise a sensing system and a pattern recognition system, with many conventional systems employing chemical sensors to analyze orders, as each odor generally leaves a characteristic pattern or fingerprint of certain compounds of which the odor is made. Known odors are oftentimes used to build a database to train and operate an odor pattern recognition system, or library of monitored signature-producing odors. A voltage change is indicative of the presence of certain chemicals or odor signature as chemical presence will alter oxygen content in the vicinity of a sensor, or electronic circuit, which a measurable change in resistance across the circuit or a voltage drop from normal or standardized conditions.

Electronic tongues may also be employed herein to monitor taste in accordance with the detection means of the invention, such as for the presence of non-volatile chemicals including molecules responsible for sweetness, bitterness, saltiness and sourness.

The employ of microbial or pathogen detection means is further contemplated for use herein especially in quality control and food processing modes of the invention. Such conventional and known techniques include a variety of electrochemical, optical and mechanical mechanisms as transuding elements. Some recent examples include biosensors for providing fast, reliable methods for detection of Escherichia coli, Salmonella typhmurium and other illness causing bacteria, such as during poultry processing, Salmonella enteritides and E. coli in milk, diary products and related products Listeria and Campylabacter and the like. An example of a conventional pathogen testing indicating systems is available from Texas Instruments.

All of the data generated in operation of the present invention may be used in conjunction with bar code or other coding technology, for example, to grade specific or desired food lots and quantities and/or used in conjunction with a computer network to receive product parameters, such as QA data, to report product line status to a control computer and to proved real time product reports.

In other aspect of the invention, the inventive method and system and its manufacture and installation provide for heretofore unavailable advantages in conducting a wide array of business functions, including designing activities, manufacture, use, marketing, sales, leasing and licensing of such products. Other advantages afforded by the inventive method, system and products are their use in generating business goodwill, in the generation of valuable trademark rights as source identifiers, and as novel and unique material and subject matter for the formation and operation of new business entities, various joint venture endeavors and collaborations.

In quality control and assurance, or otherwise processing of food stuffs and the like, the employ of food grade stainless steel in food contact items is preferred. In other embodiments materials of construction able to withstand repeated wash down with anti-bacterial products, disinfectants and detergents and the like are also preferred. Operational units such as detection means, conveyor means and the like, and perhaps data processing means as well, are also preferably mobilized, such as on wheels in or in carts and the like

Power means back-up, such as by auxiliary generator means or battery means for one or more operational units are also contemplated, especially for such functions as temperature maintenance and computer data processing and/or storage. A portion or the entire operational system in accordance with the invention may also be interfaced with a network means to enable communication of data reports and the like, such as by e-mail and other enabled devices, such as by Multimedia Messaging Service (“MMS”) text, image, photos and other multimedia messages and/or Short Message Service (“SMS”) text messages. Convenience of use and/or hygienic control means are also contemplated for preferred use herein, such as touch screens for operational feature actuation and the like.

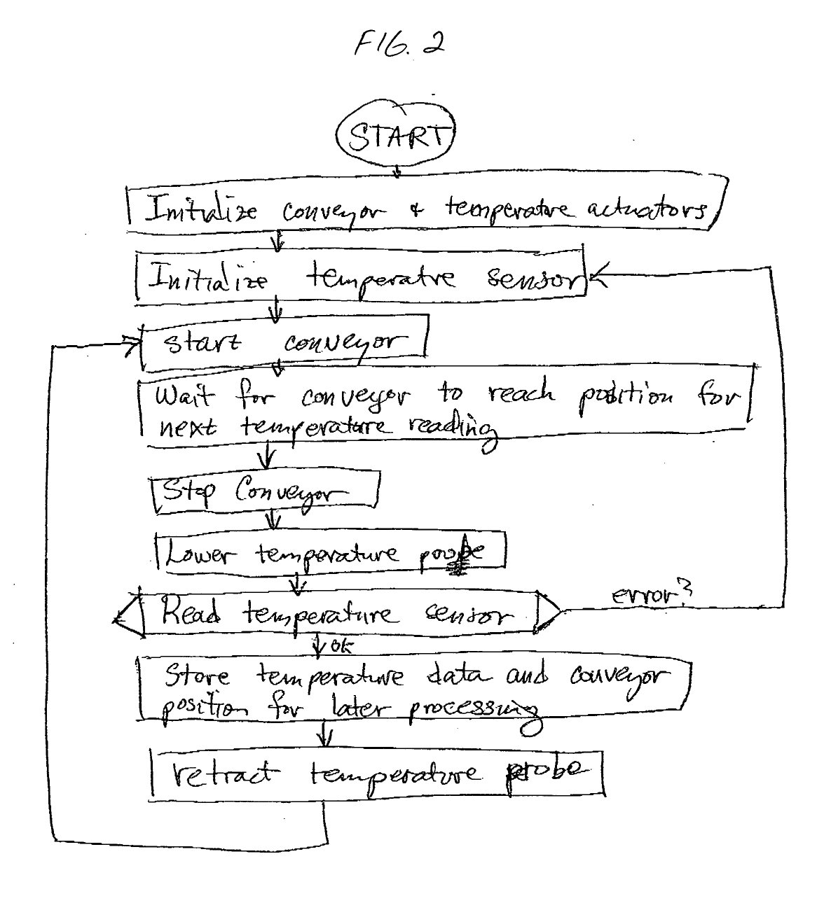

As shown in FIG. 2, there is illustrated a flow diagram of an optical sensor function as implemented by computer program code in accordance with the invention. In the following discussion with reference to the various Figs. many specific details are provided to set forth a thorough understanding of the present invention. It will be obvious, however, to those skilled in the art that the present invention may be practiced without specific details, and in some instances of this discussion with reference to the drawings known elements have not been illustrated in order not to obscure the present invention in unnecessary detail. Such details concerning computer networking, software programming, telecommunications, and the like have not been specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein may be preformed in either hardware or software, or some combination thereof In some preferred embodiments the functions are performed by a processor such as a computer or an electronic data processor in accordance with code, such as a computer program code, software, and/or integrated circuits that are coded to perform such functions.

Additionally, the processing that is depicted in the drawings and described below is generally depicted as hierarchical structure for readability and understandability. Various other methodologies, such as object-oriented techniques, are preferred for the physical embodiments of the invention in order to maximize the use of existing programming technique. One of ordinary skill in the art will appreciate that the techniques described herein may be embodied in many different forms.

For illustrative purposes only, the following discussion illustrates and discusses the present invention in reference to various embodiments which may perhaps be best utilized subject to the desires and subjective preferences of various users. One of ordinary skill in the art will, however, appreciate that the present invention may be utilized to enhance the quality assurance and food processing capability and skills in general.

Having thus prefaced this discussion, as shown in FIG. 2, from a start position, a conveyor means power is initialized and temperature detection means actuated, such as by touch screen and/or voice command operation. A temperature sensor network is then initialized. The conveyor means with conveyed products is started at a selected speed or rate, and time is elapsed for the conveyor to reach a pre-selected position to conduct a temperature reading. At this point the conveyor may be stopped, a temperature probe lowered and/or inserted or placed and the temperature detected, or a series of temperature readings extracted for, say, statistical analysis on error control. The system may also record the conveyor's position or how far a conveyor belt has moved since machine start-up. Upon a desired temperature reading or readings, such data is transmitted and stored, or correlated and the like, and the conveyor or means with conveyed products re-started at a selected speed for the next temperature reading or readings before or after, for example, of temperature measure means. In other embodiments, temperature measurements may be taken while the conveyed line is in motion with appropriate temperature measuring means, such as non-contact temperature measurement means.

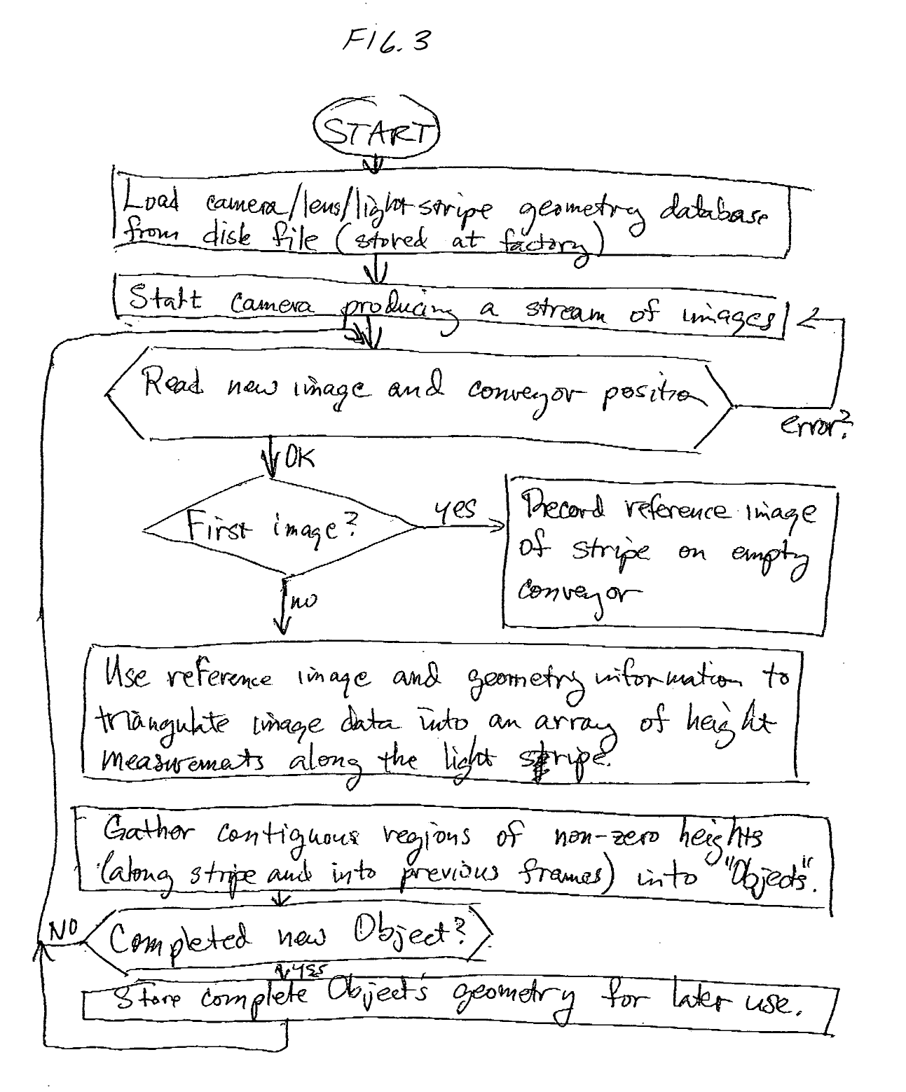

Referring now to FIG. 3, there is shown an example illustration in the form of a flow diagram of an optical sensor and functions as implemented by computer program code in accordance with the invention. As shown, after a start function, a load camera means with lens and light stripe geometry and configuration database, as controlled by a disk file, is enabled such as at processing factory station. The camera means as controlled by computer code, for example, is aimed at a light stripe projected across the conveyor surface and uses geometric triangulation to produce height measurements of the conveyor and whatever is on it; it collects contiguous regions of non-zero heights into “objects” which are analyzed. The camera is initiated in a start mode thereby producing a stream or plurality of photographic images, preferably operated with redundancy and/or for error analysis operation. Upon acceptance of an image(s), such are recorded and a record reference image of a stripe on an empty or productless, conveyor portion is recorded. The reference image and geometry information may also be used to triangulate image data into an array of height measurements along the light stripe. Contiguous regions of non-zero height, such as along the stripe and into previous frames, are gathered or collected in “objects” or bundled data. Complete objects geometry are stored for later use, or the operation is completed a desired amount of times to obtain completed new objects.

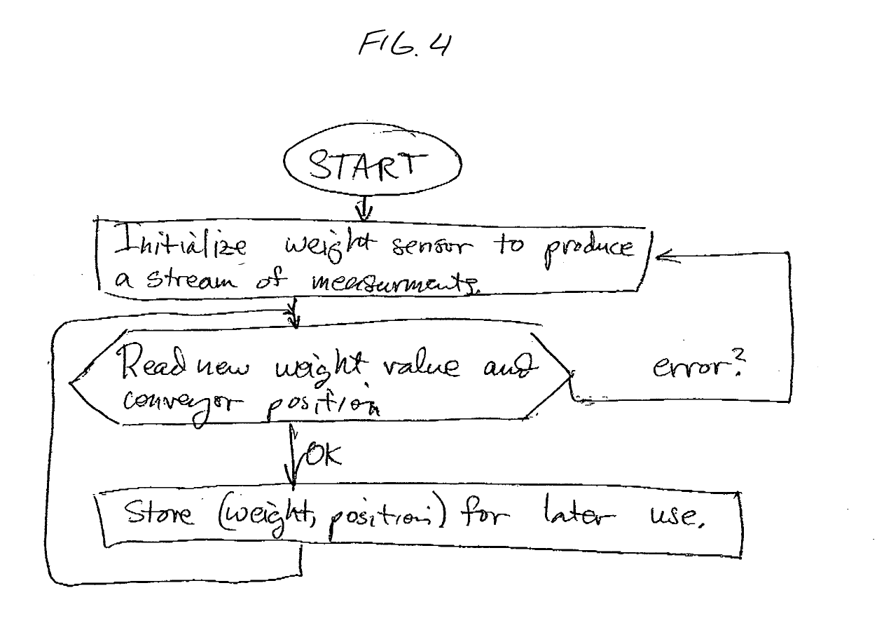

Turning now to FIG. 4, there is illustrated and example of a flow diagram of a weight sensor and function as implemented by a computer program code in accordance with the invention. After a start mode is initialized, an initial weight sensor is actuated to initialize a weight sensor to produce one or more, and preferably a plurality of measurements. The weight value per product or products is obtained per conveyed position, and error analysis preferably performed. The weight and position may then be transmitted and/or stored for later use.

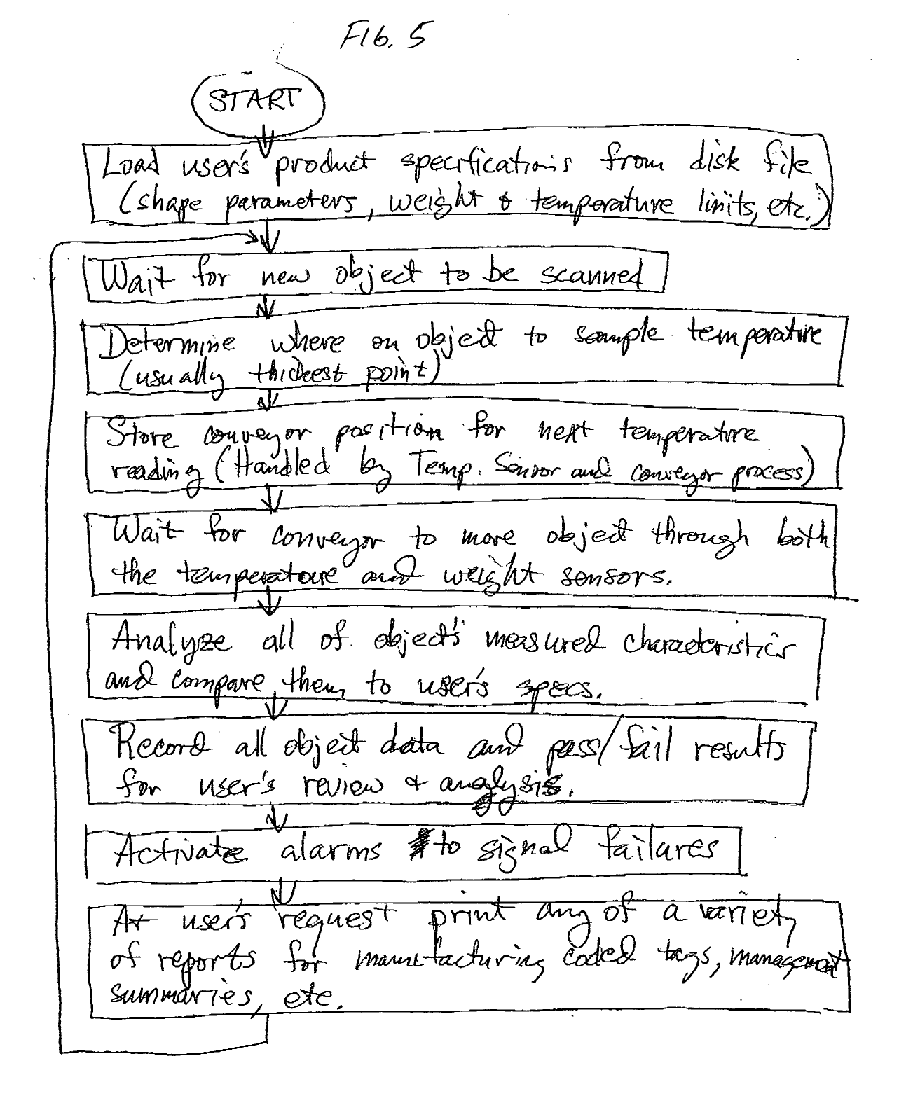

In FIG. 5, there is illustrated an example flow diagram of object processing as implemented by computer code in accordance with an embodiment of the invention in which data from a variety, or all sensor's or detection means, are coordinated and referenced against a users criteria for evaluation. After initializing a start mode, there is actuated a load user's product specifications via a disk file such as shape parameters, weight, and temperature limits/tolerances and the like. After an elapsed time parameter for an object or product to be scanned, it may be determined as to a position or geometry on an object where a temperature sample or measurement is desired, such as the thickest part of a food product or portion. The conveyor position is stored for the next temperature reading, and the conveyor means started. After an elapsed time period for the conveyor to move an object or product through, for example, temperature and weight sensors, the object's or product's measured characteristics are analyzed, and preferably compared or referenced against, for example, a user's specifications. The object data is then transmitted and/or recorded and analysis, such as pass/fail results are transmitted and/or recorded perhaps for review and analysis. There may be alarms or other indicia to signal designated failures and the like. Also, as desired, there may be obtained a print-out of one or more reports, such as for manufacturing, coded tags, management summaries and the like, all of which may be reported through any means, such as e-mail, SMS, MMS messaging, telecommunications and the like.

As may be appreciated by those skilled in the art, the conveyor means may be started before or after objects or products to be inspected are placed thereon. Inspection and/or detection data may be generated and collected in sequence, and there may be several objects or products in various stages of progress through the detection apparatus and method of the invention undergoing inspection and/or detection in a plurality of detection means simultaneously. As may be further appreciated, each of the example illustrations are shown with a start mode and without an end mode as such processes as in analogous conventional practice are designed as an infinite loop system. Additionally, the above illustrated processes, or a plurality of others, may run concurrently, such as under the control of a multitasking supervisor program, and additional detection means added as desired with minimal alteration to an existing computer program operational system for ultimate flexibility and advantages of operation.

In another aspect and embodiment of the present invention, it is further contemplated that the automated quality assurance method and apparatus may be employed in conjunction with one or more business methods, particularly methods of conducting food production operations, quality control, and stand alone quality assurance business method applications.

It will further be appreciated by those persons skilled in the art that the embodiments described herein are merely exemplary of the principles of the invention. Such are intended to be merely illustrations and not intended to limit the scope or the spirit of the invention or claims in any way, and many modifications and variations are possible without departing from the spirit and scope of the invention and claims.

1. A dynamic continuous and/or semi-continuous or static product measurement, characterizing and identifying system for food stuffs and food product portions and other objects comprising a conveyor means for transport of product or object to be measured to more than one or a plurality of detection regions to detect information comprising height, length, width, dimensional, spatial or topological characteristics, coloring characteristics, moisture content, weight, temperature, odor characteristics, taste characteristics, and the presence of pathogens while conveyed products are in motion or static or a combination thereof on said conveying means.

2. The system of claim 1, when employed to measure liquid food, rigid bulk food and/or employed in food processing and quality control.

3. The system of claim 1, wherein there are one or more discontinuities in the conveyor means.

4. The system of claim 1, wherein the conveyor means extends through one or more detection regions in one or more planes perpendicular or angled thereto, and further comprising computer means inclusive of data descriptive of the surface of the conveyor means where it extends through one or more detection regions.

5. The system of claim 4 wherein the conveyor means is of a surface shape selected from the group consisting of substantially flat, concave in portions and convex in portions.

6. The system of claim 5 wherein the surface characteristics of the conveyor means form a reference database stored in a computer means to be compared to a transported sample product or product to be measured in one or more detection means.

7. The system of claim 1 further comprising reject product conveyor means and accept product conveyor means.

8. The system of claim 1, further comprising one or more 2-D or 3-D dimensional and/or spatial characteristic measuring means effective to determine the length, width and height of an object and/or spatial or topological characteristics of an object.

9. The 2-D or 3-D measuring means of claim 8, which is an optical scanning measuring device.

10. The system of claim 1 further comprising a sample weight determining means.

11. The system of claim 1, further comprising a contact or non-contact heat or temperature sample detection means.

12. (canceled)

13. Apparatus for a dynamic continuous and/or semi-continuous or static product measurement, characterizing and identifying system for food stuffs and food product portions and other objects comprising a conveyor means for transport of product or object to be measured to One or more detection regions to detect information comprising height, length, width, dimensional, spatial or topological characteristics, coloring characteristics, moisture content, weight, temperature, odor characteristics, taste characteristics, and the present of pathogens while conveyed products are in motion or static or a combination thereof on said conveying means.

14. The apparatus of claim 13 further comprising a use to measure liquid and rigid bulk food and/or employed in food processing and quality control

15. The apparatus of claim 13 where there are one or more discontinuities in the conveyor means.

16. The apparatus of claim 13 wherein the conveyor means extends through one or more detection regions in one or more planes perpendicular or angled thereto, and further comprising computer means inclusive of data descriptive of the surface of the conveyor means where it extends through one or more detection regions.

17. The apparatus of claim 16 wherein the conveyor means is of a surface shape selected from the group consisting of substantially flat, concave in portions and convex in portions.

18. The apparatus of claim 16 wherein the surface characteristics of the conveyor means form a reference database stored in a computer means to be compared to a transported sample product to be measured in one or more detection means.

19. The apparatus of claim 13 further comprising reject product conveyor means and accept product conveyor means.

20. The apparatus of claim 13 further comprising one or more 2-D or 3-D dimensional and/or spatial characteristics measuring means effective to determine the length, width and height of an object and/or spatial or topological characteristics of an object.

21. The 2-D or 3-D measuring means of claim 20 which is an optical scanning/measuring device.

22. The apparatus of claim 13 further comprising a sample weight determining means.

23. The apparatus of claim 13 further comprising a contact or non-contact heat sample detection means.

24. (canceled)

25. A method of conducting business comprising a dynamic continuous and/or semi-continuous product measurement, characterizing and identifying system and/or apparatus for food stuffs and food product portions and other objects comprising a conveyor means for transport of product or object to be measured to more than one or a plurality of detection regions to detect information comprising height, length, width, dimensional, spatial or topological characteristics, coloring characteristics, moisture content, weight, temperature, odor characteristics, taste characteristics and the presence of pathogens while conveyed products are in motion, static or a combination thereof on said conveying means.

26. (canceled)

27. (canceled)

28. (canceled)

29. (canceled)

30. (canceled)

31. A dynamic continuous and/or semi-continuous or static product measurement, characterizing and identifying system for food stuffs and food product portions and other objects comprising a conveyor means for transport of liquid and/or rigid bulk food to be measured to a plurality of detection regions to detect information comprising height, length, width, dimensional, spatial or topological characteristics, coloring characteristics, moisture content, weight, temperature, odor characteristics, taste characteristics, and the presence of pathogens while conveyed products are in motion or static or a combination thereof on said conveying means, wherein more than one of the detection regions are configured to achieve quality control and statistical analysis over the liquid and/or rigid bulk food being measured.
